(19) United States
(12) Patent Application Publication
(10) Pub. No.: US 2006/0262010 A1
(43) Pub. Date: Nov. 23, 2006

(54) GPSR multi-frequency measuring device, corrective method and program for ionospheric delay

(75) Inventor: Tomoichi Sato, Tokyo (JP)

Correspondence Address: YOUNG & THOMPSON, 745 SOUTH 23RD STREET, 2ND FLOOR, ARLINGTON, VA, 22202, US

(73) Assignee: C/O NEC TOSHIBA SPACE SYSTEMS, LTD., TOKYO (JP)

(21) Appl. No.: 11/437,733

(22) Filed: May 22, 2006

(30) Foreign Application Priority Data
May 20, 2005 (JP) 2005-148268
May 19, 2006 (JP) 2006-140091

(51) Int. Cl. G01S 5/14

(52) U.S. Cl. 342/357.02

(57) ABSTRACT

A GPSR multi-frequency measuring ionospheric delay correction mechanism comprises an ionospheric delay corrective section for estimating an ionospheric delay coefficient based on pseudo-range data measured as an observation on multi-frequency, and for generating an ionospheric delay corrected pseudo-range based on the estimated ionospheric delay coefficient. The pseudo-range data measured as the observation on multi-frequency by using the GPS receiver or the positioning tool is acquired, and the ionospheric delay coefficient is estimated based on the pseudo-range data. An ionospheric delay corrected pseudo-range is then generated using the estimated ionospheric delay coefficient.

### BACKGROUND OF THE INVENTION

1. Field of the Invention

The present invention pertains to a field of positioning and navigation by a GPSR (GPS receiver), and relates to a GPS ionospheric delay corrective device, GPS ionospheric delay corrective method, GPS ionospheric delay corrective program, and GPS receiver. In particular, the present invention is suitably applied as an ionospheric delay correction mechanism of pseudo-range data in positioning and navigation by the GPSR of not only dual frequency receiving type but also of a general multi-frequency receiving type.

2. Description of the Related art

In the conventional dual frequency receiving type GPS receiver, an ionospheric delay corrected pseudo-range is given as a linear combination of the pseudo-ranges data in the dual frequencies of the frequency carrier waves L1 (1575.42 MHz) and L2 (1227.6 MHz).

For instance, in “Ionic layer corrective method with respect to GPS receiver of single frequency using two satellites” disclosed in Japanese Laid-Open Patent Publication No. 2000-310674, a technique for overcoming the fact that only one frequency L1 can be received in the general GPS receiver due to reason of security is disclosed. As described in the section of Background Art in Japanese Laid-Open Patent Publication No. 2000-310674, if two different GPS frequencies L1 and L2 are used, the delay of the GPS signal caused by the interference of the ionosphere can be completely corrected in theory by obtaining the difference in the arrival time of the two frequencies on the assumption that the affect of the observation noise is not taken into consideration.

### SUMMARY OF THE INVENTION

In the conventional method, the receiving frequency is limited to two waves, and no consideration is made on the general multi-frequency GPS signal including a plurality of frequencies L1, L2, L5 (1176.45 MHz) etc. to be expected in the future. Therefore, the pseudo-range data in which the ionospheric delay is corrected cannot be obtained from each pseudo-range data, that is, the distance data between the GPS satellite and the GPS receiver calculated from the propagation time difference obtained by using the time information of the GPS receiver, since they do not give an algorithm about the best combination of them.

Further, in a case of the GPS signal of dual frequencies, there is no endurance against the data defect of one frequency in the combination of dual frequencies. Further, since correction is made for each shot the data is acquired, the correction value itself tends to be influenced by and be subjected to observation noise contained in each observation data.

The present invention aims to provide a GPS ionospheric delay corrective device capable of calculating the pseudo-range data in which the ionospheric delay is corrected not only for dual frequencies but even for multi-frequency of two or more frequencies according to the same common algorithm by suitably weighing and synthesizing each observation data of multi-frequency, as well as delay corrective method and program, and GPS receiver.

The present invention further aims to provide a simple and practicable method for minimizing the error of correction of the ionospheric delay caused by the influence of observation noise contained in each observation data.

In order to achieve the above aim, a GPSR multi-frequency measuring ionospheric delay corrective device according to the present invention comprises an ionospheric delay corrective section for estimating an ionospheric delay coefficient based on pseudo-range data measured as an observation on multi-frequency, and generating an ionospheric delay corrected pseudo-range based on the estimated ionospheric delay coefficient.

According to the present invention, the pseudo-range data measured as an observation on multi-frequency measured using a GPS receiver or a positioning tool is acquired, and the ionospheric delay coefficient is estimated based on the pseudo-range data. The ionospheric delay corrected pseudo-range is then generated using the estimated ionospheric delay coefficient.

In estimating the ionospheric delay coefficient, the Kalman Filter technique is used in which a method of variation of constant is applied to an ionospheric delay model for setting a delay of the ionosphere, or a spline filter is used in which a model constant is assumed to change so as to approximate in a polynomial of time, in place of the Kalman Filter technique. Alternatively, a multi-frequency algorithm in which the least squares method is applied to the observation residual is used.

Therefore, in the present invention, a value in which the ionospheric delay is corrected is calculated as the optimum synthesis based on the pseudo-range observation data measured as the observation on multi-frequency, the filter estimation technique such as the Kalman Filter technique is applied to the model constant of the ionospheric delay model to minimize the affect of the observation noise contained in each observation data, and the correction of ionospheric delay is calculated at high precision.

The present invention may be a GPSR multi-frequency measuring ionospheric delay corrective program for having a computer configuring the GPSR multi-frequency measuring ionospheric delay corrective device to calculate the correction of ionospheric delay. The GPSR multi-frequency measuring ionospheric delay corrective program according to the present invention is configured to execute a function of estimating an ionospheric delay coefficient based on pseudo-range data measured as an observation on multi-frequency, and generating the ionospheric delay corrected pseudo-range based on the estimated ionospheric delay coefficient.

The program may be configured to have the computer execute a function of estimating the ionospheric delay coefficient using the Kalman Filter technique in which a method of variation of constant is applied to an ionospheric delay model for setting a delay of the ionosphere, or executing a function of estimating the ionospheric delay coefficient using the spline filter in which a model constant is assumed to change so as to approximate in a polynomial of time, in place of the Kalman Filter technique. Alternatively, the program may be configured to have the computer execute a function of estimating the ionospheric delay coefficient using the multi-frequency algorithm in which the least squares method is applied to the observation residual.

According to the present invention as described above, calculation of the ionospheric delay correction value is performed under optimum distribution with respect to not only the observation data of dual frequency, but also with respect to the general observation data of multi-frequency of two or more frequencies.

The accuracy of the ionospheric delay correction is enhanced since the algorithm in which the affect of the noise of the observation with respect to the correction value is minimized is used in estimating the ionospheric delay coefficient. Further, resistance to lack of data is realized since filter estimation is used in estimating the ionospheric delay coefficient.

### BRIEF DESCRIPTION OF THE DRAWINGS

The invention, together with objects and advantages thereof, may best be understood by reference to the following description of the presently preferred embodiment together with the accompanying drawings in which:

FIG. 1 is a block configuration view showing one example of a schematic configuration of a GPS receiver according to an embodiment of the present invention;

FIG. 2 is a flow chart showing one example of a processing procedure of a GPS ionospheric delay corrective program according to the present invention; and

FIG. 3 is a view showing a relationship between a GPS satellite and a GPS receiver.

### DETAILED DESCRIPTION OF THE PREFERRED EMBODIMENTS

The embodiment of the present invention will now be described in detail based on the figures.

For the basic configuration, the GPSR multi-frequency measuring ionospheric delay corrective device according to the present invention applies the Kalman Filter technique estimating technique for the ionospheric delay coefficient, and formulates the filter into a variational form to ensure correspondence with respect to a plurality of pseudo-range data measured as multi-frequency observation. The method of variation of constant for formulating into the variational form is one solution to linear differential equation, and is a method of performing variable transformation of the equation with a general constant (integral constant) in the expression of the solution being freshly considered as a variable while using the expression based on the expression of the solution of a similar equation.

Further, a formula applying the method of variation of constant is adopted for the ionospheric delay model with regards to the selection of a state variable in consideration of minimizing the affect of the observation noise, enhancing the accuracy of distance measuring, and obtaining resistance to lack of data. When formulating the filter to the variational form, the observing action is provided through “the sum of squares of a form in which observation residual form relating to pseudo-range is standardized at observation noise level” to realize an optimum distribution of the accuracy of observation.

The GPSR multi-frequency measuring ionospheric delay corrective device according to the present invention is a device that mounts the ionospheric delay corrective program using the above described algorithm to an MPU (Micro Processing Unit) of a computer such as a GPS receiver, estimates the ionospheric delay coefficient at high precision and high reliability, performs ionospheric delay corrective calculation of high precision on the observation, and outputs the corrected pseudo-range data and the ionospheric vertical delay coefficient at the pears points.

The GPSR multi-frequency measuring ionospheric delay corrective device according to the present invention reads the pseudo-range data measured as the observation on multi-frequency, estimates the ionospheric delay coefficient at high precision through filter estimation, performs ionospheric delay correction calculation on the pseudo-range data measured as the observation using the estimated ionospheric delay coefficient, and outputs the corrected pseudo-range data. The ionospheric delay corrected pseudo-range data of high precision in which the ionospheric delay is corrected is thereby output, and high precision positioning and navigation becomes possible based thereupon. Further, the ionospheric vertical delay coefficient at the pears point is calculated. The pears point refers to the ionosphere pass through point where the GPS signal of multi-frequency passes through the ionosphere.

An example in which the GPSR multi-frequency measuring ionospheric delay corrective device according to the present invention is applied to the GPS receiver will now be explained by way of an embodiment.

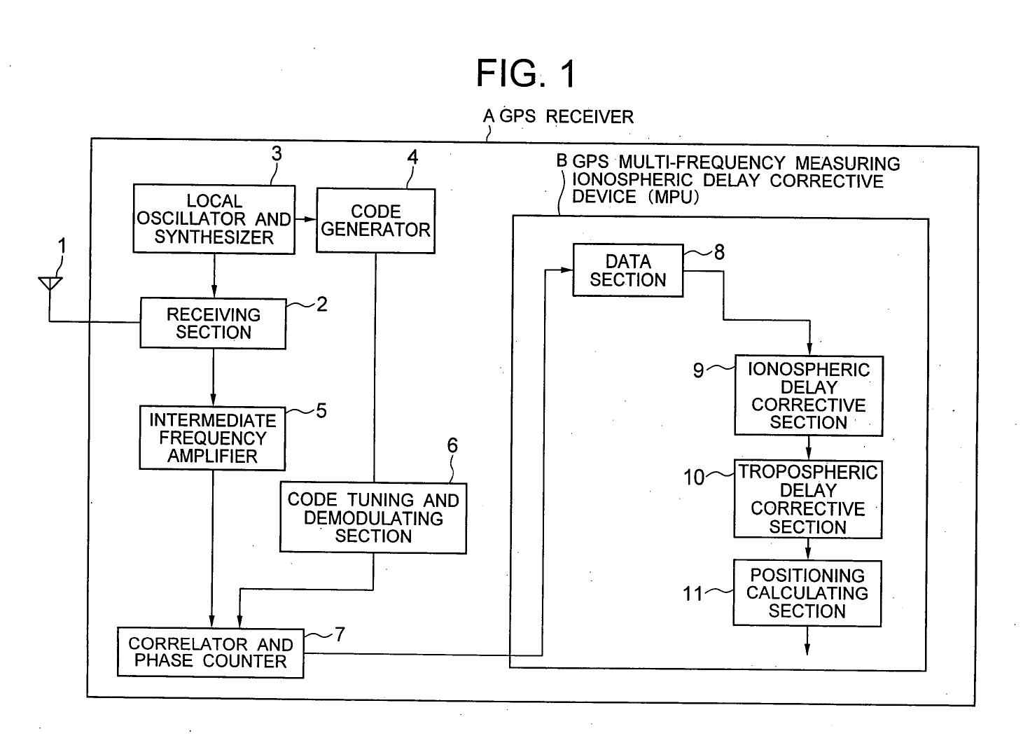

As shown in FIG. 1, the GPS receiver A includes a receiving section 2 for receiving the GPS signal from an antenna 1, a local oscillator and synthesizer 3, a code generator 4, an intermediate frequency amplifier 5, a code tuning and demodulating section 6, a correlator and phase counter 7, and a GPS multi-frequency measuring ionospheric delay corrective device B according to the present invention. The GPS multi-frequency measuring ionospheric delay corrective device B is built into a configuration of having the MPU execute the processing algorithm by the GPS ionospheric delay corrective program to execute the functions of a data section 8, an ionospheric delay corrective section 9, a tropospheric delay corrective section 10, and a positioning calculating section 11.

The local oscillator and synthesizer 3 has a function of generating the fundamental frequency of the receiver 1 and outputting a plurality of coherent frequencies. The receiving section 2 has a function of receiving the GPS signal from the antenna 1, performing frequency conversion (down conversion) on the GPS signal based on the frequency signal from the local oscillator and synthesizer 3 and outputting the frequency converted signal to the intermediate frequency amplifier 5. The intermediate frequency amplifier 5 has a function of amplifying the frequency converted signal output from the receiving section 2, and outputting the amplified signal to the correlator and phase counter 7.

The code generator 4 has a function of generating the PRN code signal based on the signal from the local oscillator and synthesizer 3 and outputting the PRN code signal to the correlator and phase counter 7. The code tuning and demodulating section 6 has a function of performing the code tuning process based on the signal from the code generator 4, calculating the correlation with the diffusion signal of the replica of the spread code, locking the spread code, demodulating the navigation signal, and outputting the navigation signal to the correlator and phase counter 7.

The correlator and phase counter 7 has a function of measuring the time difference for holding the lock of the spread code and the phase difference for holding the carrier lock, and outputting the pseudo-range measurement data ρⱼ of multi-frequency and the carrier wave phase data φⱼ, and generating the navigation message (Nav. MSG) parameter based on the result and outputting the same to the GPS ionospheric delay corrective device B.

According to the above configuration, the pseudo-range data ρⱼ measured as the observation on multi-frequency is calculated by the pseudo-range measuring function of the GPS receiver. Here, j is an index relating to frequency.

The data section 8 of the GPS multi-frequency measuring ionospheric delay corrective device B has a function of acquiring the pseudo-range data ρⱼ measured as the observation on multi-frequency outputted by the correlator and phase counter 7. The ionospheric delay corrective section 9 has a function of performing the correction process of satellite clock and the correction process of intra-satellite delay, as well as the process of high precision ionospheric delay correction responding to multi-frequency on the pseudo-range data ρⱼ acquired by the data section 8.

The feature of the embodiment of the present invention lies in the process of high precision ionospheric delay correction responding to multi-frequency performed by the ionospheric delay corrective section 9. That is, the ionospheric delay correction section 9 adopts the filter estimation applied with the method of variation of change for the ionospheric delay model with respect to the signal outputted from the data section 8 to estimate the ionospheric vertical delay coefficient regarding the observed pseudo-range data ρⱼ of multi-frequency at high precision. Further, the ionospheric delay correction section 9 has a function of, using the estimated ionospheric delay coefficient, performing the ionospheric delay corrective calculation on the observed pseudo-range data of multi-frequency, synthesizing the correction of ionospheric delay based on the distribution suitably weighed according to the observation noise level, and outputting the ionospheric delay corrected pseudo-range data.

Specifically explaining, the ionospheric delay corrective section 9 performs the following data process based on a generally standard Kalman Filter technique method after the initial setting of the estimation system.

1) Acquire pseudo-range ρⱼ of multi-frequency measured as observation data,

2) Propagate estimation standard deviation σ of an ionospheric group delay correction exponent ν from the time of previous data acquisition to the time of last data acquisition.

3) Update the estimated value νₒ of the ionospheric group delay correction exponent ν based on the observation data (pseudo-range ρⱼ of multi-frequency) and the estimation standard deviation σ.

4) Update the estimated value of the ionospheric delay coefficient K, the ionospheric delay coefficient K being defined as a function of the ionospheric group delay correction exponent ν as described hereinafter.

5) Calculate the ionospheric group delay corrected pseudo-range ρ and the noise level σ^{G} thereof through optimum synthesis.

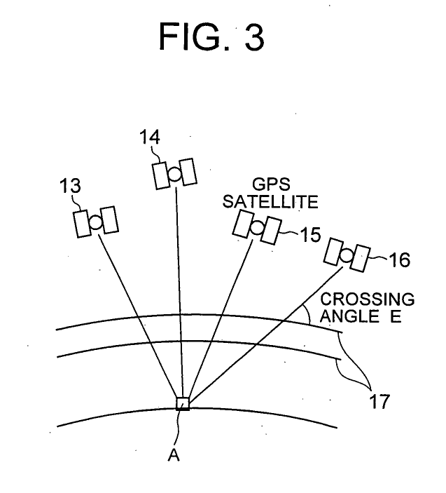

The ionospheric delay coefficient K is a proportionality coefficient of when the ionospheric group delay for the positioning signal of each GPS satellite 13, 14, 15, 16 shown in FIG. 3 is expressed as K·(f_{L}/fⱼ)⁻². Taking the correction factor exp(ν) into consideration for the existing ionospheric delay model M(LST, φ) with respect to the ionospheric delay coefficient K, K=exp(ν)·M(LST, φ)/cos(E) is provided.

M in the ionospheric delay model is a model equation related to the vertical delay of the ionosphere, where Klobuchar Model and the like is known in GPS. LST in the ionospheric delay model is the local sun time of the pears point, and φ in the ionospheric delay model is the geomagnetic latitude. Further, E of the signal represents the ionospheric crossing angle shown in FIG. 3. These are amounts determined when the position of the GPS satellite and the user, and the receiving time are roughly obtained.

Since the model shows the outline of the change in the ionospheric group delay, ν is assumed as a constant when seen from a certain time measurement τ. That is, the above described conversion is said to be an application of one type of the way of thinking the method of variation of constant.

The filter of the ionospheric group delay correction exponent is defined in the following manner under the above outline. That is,

State variable: ν (group delay correction exponent)

Equation of motion dν/dt=0

The pseudo-range data ρⱼ is considered for the observation. The observation equation is as follows. The equation is expressed in terms of inertia system where the light velocity is taken as unit (C=1).
ρⱼ=ρ+K·(fⱼ/f_{L})+N^{G}ⱼ

where, ρ is the ionospheric delay corrected pseudo-range, and N^{G}ⱼ is the pseudo-range observation noise. The noise level is assumed as σ^{G}ⱼ, and the information dissipation time constant as τ.

The tropospheric delay corrective section 10 has a function of performing other delay corrections of intra-troposphere/system etc. with respect to the signal outputted from the ionospheric delay corrective section 9, and outputting the corrected signal to the positioning calculating section 11. The positioning calculating section 11 has a function of processing the signal outputted from the tropospheric delay corrective section 10, and externally outputting the positioning/navigation data such as the results of receiver's position & CLOCK estimation and the like.

A configuration of using the filter estimation of a formula applied with the method of variation constant for the ionospheric delay model in estimating the ionospheric delay coefficient to reduce the affect of instantaneous noise and to enhance accuracy of estimation is adopted in the embodiment of the present invention, but is not limited thereto, and as long as the idea of the same type is used, a spline filter that assumes that the model constant changes so as to approximate in a polynomial of time may be applied in place of the Kalman Filter technique. The resistance to the lack of observation data and instantaneous noise is obtained by using such filter estimation. Further, by obtaining the correction of ionospheric delay using the same algorithm with respect to the pseudo-range observation data of each frequency, performing optimum distribution weighed according to the observation noise level and synthesizing each correction of ionospheric delay, the affect of the observation noise contained in the observation data is reduced to as small as possible.

A method of performing the process of ionospheric delay correction using the GPS receiver A according to the embodiment of the present invention will now be described.

As shown in FIG. 3, when the GPS signal outputted to earth from the GPS satellites 13, 14, 15, 16 of different frequency through the ionosphere 17 is received by the antenna 1 of the GPS receiver A shown in FIG. 1, the GPS signal is then inputted to the receiving section 2. In this case, the local oscillator and synthesizer 3 shown in FIG. 1 generates the fundamental frequency of the receiver 1, and outputs the plurality of coherent frequencies to the receiving section 2 and the code generator 4.

The receiving section 2 receives the GPS signal from the antenna 1, frequency converts (down converts) the GPS signal based on the frequency signal from the local oscillator and synthesizer 3 and outputs the frequency converted signal to the intermediate frequency amplifier 5. The signal amplified in the intermediate frequency amplifier 5 is then inputted to the code tuning and demodulating section 6, which signal is then performed with the code tuning process by the code tuning and demodulating section 6 based on the signal from the code generator 4. The code tuning and demodulating section 6 calculates the correlation with the diffusion signal of the replica of the spread code, locks the spread code, demodulates the navigation signal, and outputs the navigation signal to the correlator and phase counter 7.

The correlator and phase counter 7 receives the signal outputted from the code tuning and demodulating section 6 and the signal output from the code generator 4 as inputs, measures the time difference for holding the lock of the spread code and the phase difference for holding the carrier lock, and outputs the pseudo-range data ρⱼ measured as the observation on multi-frequency to the GPS multi-frequency measuring ionospheric delay corrective device B.

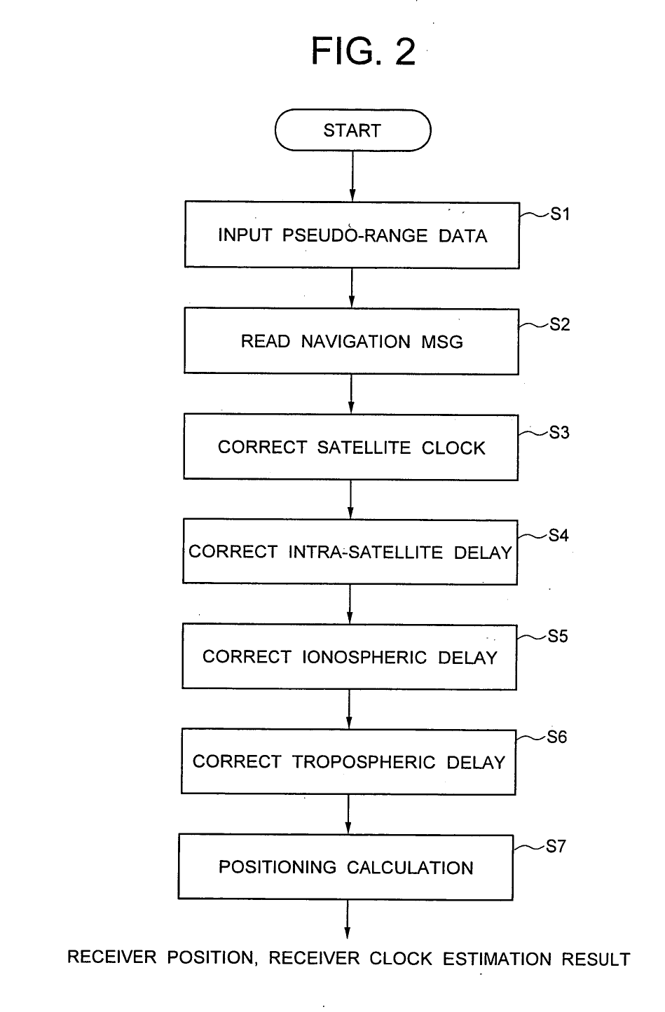

A series of processes performed in the GPS multi-frequency measuring ionospheric delay corrective device B will now be explained based on FIG. 2.

The GPS multi-frequency measuring ionospheric delay corrective device B executes the program and performs the initial setting.

That is, the ionospheric group delay correction exponent ν is set to 0, and the estimation standard deviation σ of the ionospheric group delay correction exponent is set to 1. That is, the range of about e⁻¹K₀<K<e¹·K₀(e≈2.718) is assumed as the priori range of the ionospheric delay coefficient K in this case.

In step S1 of FIG. 2, the pseudo-range data ρⱼ measured as the observation on multi-frequency measured by the GPS receiver is inputted, and the pseudo-range ρⱼ measured as the observation on multi-frequency is read as the observation data. Since the pseudo-range data ρⱼ is periodically obtained from the output of the correlator of the GPS receiver, the value is handled as the input for the estimation program.

In step S2 of FIG. 2, the navigation MSG (GPS position information, clock information etc.) is read based on the signal from the data section 8, and the usual correction of the satellite clock and the usual correction of the intra-satellite delay are performed in steps S3 and S4, respectively.

In step S5, the process of ionospheric delay correction responding to multi-frequency, which is the feature of the present invention, is performed. This process includes propagation of estimation and update of estimation.

The propagation of estimation includes the propagating step of estimated state and the propagating step of the estimation standard deviation. Since the method of variation of constant is adopted in the propagating step of estimated state, this step can be skipped generally in Kalman Filter calculation steps because of the assumption that the equation of motion is dν/dt=0.

In the propagation of estimation standard deviation a the propagation due to estimating information dissipation is performed based on the following equation with regards to the estimation standard deviation σ of the ionospheric group delay correction exponent ν.
σ=σ·exp(Δt/τ)
where, Δt is the interval of the propagation, specifically, the elapsed time from the previous update. τ is the time constant of estimating information dissipation (program constant).

The update of estimation mentioned above includes update of estimated state and update of estimation standard deviation.

In the updating step of estimated state, the updated values of the ionospheric group delay correction exponent v and the ionospheric delay corrected pseudo-range p are calculated. The update is calculated based on the principle of least action.

In this case, the observing action A_{obs} is given by the following equation.

The observed value is substituted as A_{obs}=0.5Σ(ρⱼ−ρ−K·(fⱼ/f_{L})⁻²)²·σ^{G}ⱼ⁻², ρⱼ.

Further, assume K≡exp(ν)·M(LST, φ)/cos(E)

The pre-observation estimating action Aₑₛₜ is given in the following equation.

Aₑₛₜ=0.5·(ν−ν₀)²·σ⁻², where ν₀ is the ν estimated value before update.

The total action is defined as A=A_{obs}+Aₑₛₜ

The updated value of the ionospheric group delay correction exponent ν and estimated value of the ionospheric group delay corrected pseudo-range ρ are obtained by solving the following equation. Iteration is partially used as described above for solving.
∂A/∂ρ=0; linear equation relating to ρ
∂A/∂ν=0; that is, K·∂A_{obs}/∂K+(ν−ν₀)·σ⁻²=0

It can be solved by using Newton-Raphson Method with the initial value as ν=ν₀.

Alternatively, ν is updated as iteration or ν=ν₀+σ²K·∂A_{obs}/∂K.

Subsequently, the pseudo-range ρ after ionospheric group delay correction is re-calculated. One cycle of iteration will be sufficient for solving this equation.

The process of updating the estimation standard deviation includes the process of updating the estimation standard deviation σ of the ionospheric group delay correction exponent ν and the process of calculating the estimation standard deviation σ^{G} of the ionospheric delay corrected pseudo-range ρ.

The update of the estimation standard deviation σ of the ionospheric group delay correction exponent ν will now be explained. The covariance update relating to ν is carried out using σ⁻²=σ⁻²+∂²A_{obs}/∂²ν.

Moreover, ∂²A_{obs}/∂²ν can be calculated as K·∂A_{obs}/∂K+K²∂²A_{obs}/∂²K.

The calculation of the estimation standard deviation σ^{G} of the ionospheric delay corrected pseudo-range ρ will now be explained.

The estimation standard deviation σ^{G} of the ionospheric group delay corrected pseudo-range is calculated by,
(σ^{G})⁻²=∂²A/∂²ρp=∂²A_{obs}/∂²ρ, that is, (σ^{G})⁻²=Σ(σ^{G}ⱼ)⁻².

After the above processes are finished, the usual correction of the tropospheric delay is performed in step S6, and the usual positioning and navigation calculation is performed in step S7. The process then returns to step S1 or input of pseudo-range data. In step S7, the receiver position and the CLOCK estimation result are outputted.

The embodiment of the present invention is not limited to the above explanation. That is, the ionospheric delay corrective method that is not limited to dual frequency (adapatable to dual frequency, three frequencies) may be achieved by only adopting the general multi-frequency algorithm in which the least squares method is applied to the observation residual, without using the estimating method of Kalman Filter technique in calculating the ionospheric delay coefficient K. The affect of the observation noise may be reduced by adopting the spline filter and the like as a form of Kalman Filter technique used in calculating the ionospheric delay coefficient K.

Therefore, the multi-frequency measuring high precision ionospheric delay corrective function may be incorporated in measurement equipments including the multi-frequency receiving type GPS receiver (GPSR), navigation equipments such as aviation, boats and ships etc.

It should be apparent to those skilled in the art that the present invention may be embodied in many other specific forms without departing from the spirit or scope of the invention. Therefore, the present invention is not to be limited to the details given herein, but may be modified within the scope and equivalence of the appended claims.

What is claimed is:

1. A GPSR multi-frequency measuring ionospheric delay corrective device comprising an ionospheric delay corrective section for estimating an ionospheric delay coefficient based on pseudo-range data measured as an observation on multi-frequency, and for generating an ionospheric delay corrected pseudo-range based on the estimated ionospheric delay coefficient.

2. The GPSR multi-frequency measuring ionospheric delay corrective device as claimed in claim 1, wherein the ionospheric delay corrective section estimates the ionospheric delay coefficient using Kalman Filter technique in which a method of variation of constant is applied to an ionospheric delay model for setting a delay of ionosphere.

3. The GPSR multi-frequency measuring ionospheric delay corrective device as claimed in claim 2, wherein the ionospheric delay corrective section uses a spline filter in which a model constant is assumed to change so as to approximate in a polynomial of time in place of the Kalman Filter technique.

4. The GPSR multi-frequency measuring ionospheric delay corrective device as claimed in claim 1, wherein the ionospheric delay corrective section estimates the ionospheric delay coefficient using a multi-frequency algorithm in which the least squares method is applied to the observation residuals.

5. A GPSR multi-frequency measuring ionospheric delay corrective program which is possible to be installed in a computer configured in a GPSR as a multi-frequency measuring ionospheric delay corrective device in order to execute a function of estimating an ionospheric delay coefficient based on pseudo-range data measured as an observation on multi-frequency, and a function of generating an ionospheric delay corrected pseudo-range based on the estimated ionospheric delay coefficient.

6. The GPSR multi-frequency measuring ionospheric delay corrective program as claimed in claim 5, for having the computer execute a function of estimating the ionospheric delay coefficient using Kalman Filter technique in which a method of variation of constant is applied to an ionospheric delay model for setting a delay of the ionosphere.

7. The GPSR multi-frequency measuring ionospheric delay corrective program as claimed in claim 6, for having the computer execute a function of estimating the ionospheric delay coefficient using a spline filter in which a model constant is assumed to change so as to approximate in a polynomial of time in place of the Kalman Filter technique.

8. The GPSR multi-frequency measuring ionospheric delay corrective program as claimed in claim 5, for having the computer execute a function of estimating the ionospheric delay coefficient using a multi-frequency algorithm in which the least squares method is applied to the observation residual.

9. A GPSR multi-frequency measuring ionospheric delay corrective method comprising:
a first step of acquiring pseudo-range data measured as an observation on multi-frequency;
a second step of estimating an ionospheric delay coefficient based on the pseudo-range data, and generating an ionospheric delay corrected pseudo-range based on the estimated ionospheric delay coefficient.

10. The GPSR multi-frequency measuring ionospheric delay corrective method as claimed in claim 9, wherein the ionospheric delay coefficient is estimated using Kalman Filter technique in which a method of variation of constant is applied to an ionospheric delay model for setting a delay of ionosphere.

11. The GPSR multi-frequency measuring ionospheric delay corrective method as claimed in claim 10, wherein the ionospheric delay coefficient is estimated using a spline filter in which a model constant is assumed to change so as to approximate in a polynomial of time in place of the Kalman Filter technique.

12. The GPSR multi-frequency measuring ionospheric delay corrective method as claimed in claim 10, wherein the ionospheric delay coefficient is estimated using a multi-frequency algorithm in which the least squares method is applied to the observation residual.
